(19) United States
(12) Patent Application Publication
(10) Pub. No.: US 2014/0218370 A1
(43) Pub. Date: Aug. 7, 2014

(54) METHOD, APPARATUS AND COMPUTER PROGRAM PRODUCT FOR GENERATION OF ANIMATED IMAGE ASSOCIATED WITH MULTIMEDIA CONTENT

(71) Applicants: Pranav MISHRA, Bangalore (IN); Rajeswari Kannan, Bangalore (IN)

(72) Inventors: Pranav MISHRA, Bangalore (IN); Rajeswari Kannan, Bangalore (IN)

(73) Assignee: Nokia Corporation, Espoo (FI)

(21) Appl. No.: 13/680,883

(22) Filed: Nov. 19, 2012

(30) Foreign Application Priority Data
Nov. 24, 2011 (IN) 4042/CHE/2011

(51) Int. Cl. G06T 13/20

(52) U.S. Cl. CPC G06T 13/20
USPC 345/473

(57) ABSTRACT

In accordance with an example embodiment a method, apparatus and computer program product are provided. The method comprises facilitating selection of at least one object from a plurality of objects in a multimedia content. The method also comprises accessing an object mobility content associated with the at least one object. The object mobility content is indicative of motion of the plurality of objects in the multimedia content. An animated image associated with the multimedia content is generated based on the selection of the at least one object and the object mobility content associated with the at least one object.

### TECHNICAL FIELD

Various implementations relate generally to method, apparatus, and computer program product for generation of animated images from multimedia content.

### BACKGROUND

In recent years, various techniques have been developed for digitization and further processing of multimedia content. Examples of multimedia content may include, but are not limited to a video of a movie, a video shot, and the like. The digitization of the multimedia content facilitates in complex manipulation of the multimedia content for enhancing user experience with the digitized multimedia content. For example, the multimedia content may be manipulated and processed for generating animated images that may be utilized in a wide variety of applications. Animated images include a series of images encapsulated within an image file. The series of images may be displayed in a sequence, thereby creating an illusion of movement of objects in the animated image.

### SUMMARY OF SOME EMBODIMENTS

Various aspects of examples of examples embodiments are set out in the claims.

In a first aspect, there is provided a method comprising: facilitating selection of at least one object from a plurality of objects in a multimedia content; accessing an object mobility content associated with the at least one object, the object mobility content being indicative of motion of the plurality of objects in the multimedia content; and generating an animated image associated with the multimedia content based on the selection of the at least one object and the object mobility content associated with the at least one object.

In a second aspect, there is provided an apparatus comprising at least one processor; and at least one memory comprising computer program code, the at least one memory and the computer program code configured to, with the at least one processor, cause the apparatus to perform at least: facilitating selection of at least one object from a plurality of objects in a multimedia content; accessing an object mobility content associated with the at least one object, the object mobility content being indicative of motion of the plurality of objects in the multimedia content; and generating an animated image associated with the multimedia content based on the selection of the at least one object and the object mobility content associated with the at least one object.

In a third aspect, there is provided a computer program product comprising at least one computer-readable storage medium, the computer-readable storage medium comprising a set of instructions, which, when executed by one or more processors, cause an apparatus to perform at least: facilitating selection of at least one object from a plurality of objects in a multimedia content; accessing an object mobility content associated with the at least one object, the object mobility content being indicative of motion of the plurality of objects in the multimedia content; and generating an animated image associated with the multimedia content based on the selection of the at least one object and the object mobility content associated with the at least one object.

In a fourth aspect, there is provided an apparatus comprising: means for facilitating selection of at least one object from a plurality of objects in a multimedia content; means for accessing an object mobility content associated with the at least one object, the object mobility content being indicative of motion of the plurality of objects in the multimedia content; and means for generating an animated image associated with the multimedia content based on the selection of the at least one object and the object mobility content associated with the at least one object.

In a fifth aspect, there is provided a computer program comprising program instructions which when executed by an apparatus, cause the apparatus to: facilitate selection of at least one object from a plurality of objects in a multimedia content; access an object mobility content associated with the at least one object, the object mobility content being indicative of motion of the plurality of objects in the multimedia content; and generate an animated image associated with the multimedia content based on the selection of the at least one object and the object mobility content associated with the at least one object.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for generating animated image associated with multimedia content in accordance with an example embodiment;

FIGS. 3A and 3B illustrate a user interface (UI) for generating animated image associated with multimedia content in an apparatus in accordance with an example embodiment;

FIGS. 4A, 4B and 4C illustrate exemplary user interface (UI) for generating animated image associated with multimedia content in an apparatus in accordance with another example embodiment;

FIG. 5 is a flowchart depicting an example method for generating animated image associated with multimedia content in accordance with an example embodiment; and

FIGS. 6A-6B is a flowchart depicting an example method for generating animated image associated with multimedia content in accordance with another example embodiment.

### DETAILED DESCRIPTION

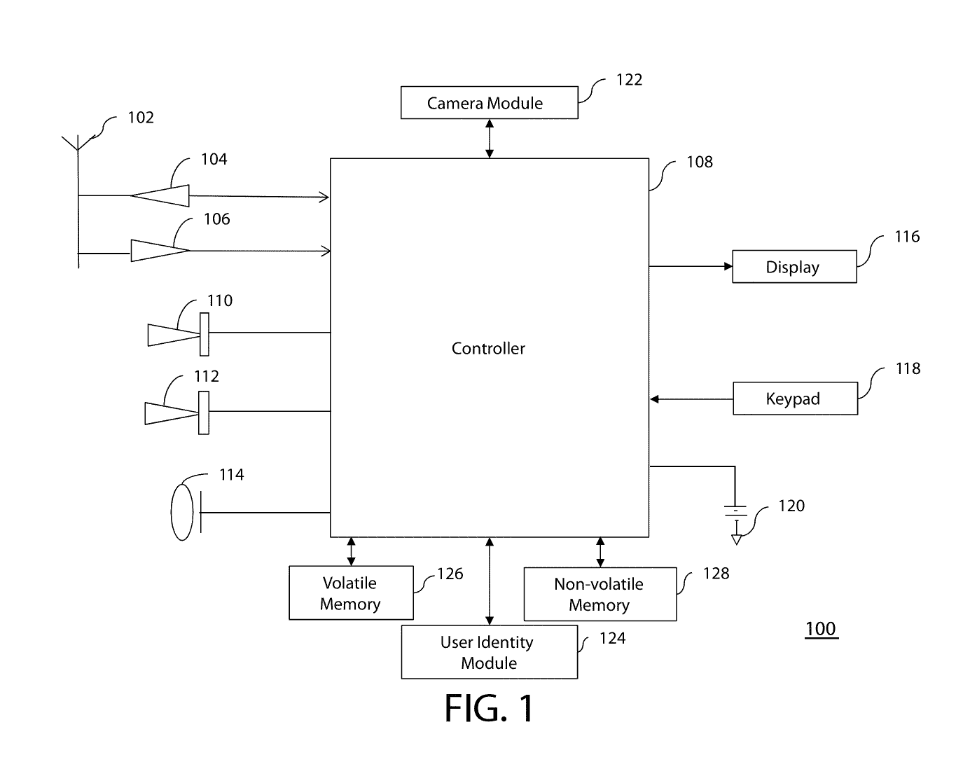

Example embodiments and their potential effects are understood by referring to FIGS. 1 through 6B of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

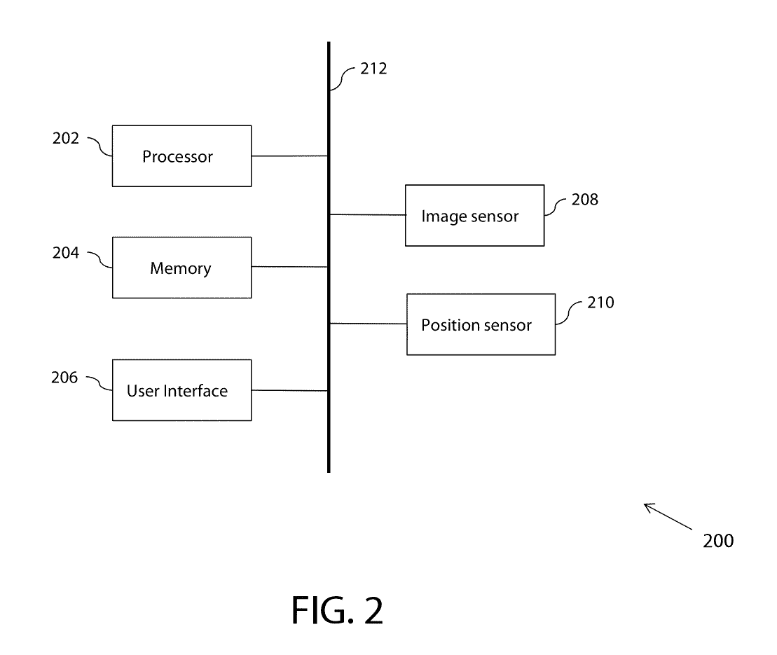

FIG. 2 illustrates an apparatus 200 for generating animated images associated with a multimedia content, in accordance with an example embodiment. In an embodiment, the multimedia content is a video recording or a video shot in a burst mode, for example, for about 3-4 seconds. Examples of the multimedia content may include a video presentation of a television program or a video shot, a short movie shot by a multimedia capturing device, and the like. In an embodiment, the multimedia content may be captured by a media capturing device, for example, the device 100. Examples of the multimedia capturing device may include, but are not limited to, a camera, a mobile phone having multimedia capturing functionalities, and the like. In an embodiment, the multimedia content may be captured by using 3-D cameras, 2-D cameras, and the like.

The apparatus 200 may be employed for generating the animated image associated with the multimedia content, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices. Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the communication device may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100.

In an example embodiment, the communication device may be embodied as to include an inertial/position sensor 210. The inertial/sensor 210 may be in communication with the processor 202 and/or other components of the apparatus 200. The inertial/positional sensor 210 may be in communication with other imaging circuitries and/or software, and is configured to track movement/navigation of the apparatus 200 from one position to another position.

These components (202-210) may communicate to each other via a centralized circuit system 212 to perform capturing of 3-D image of a scene associated with the multimedia content. The centralized circuit system 212 may be various devices configured to, among other things, provide or enable communication between the components (202-210) of the apparatus 200. In certain embodiments, the centralized circuit system 212 may be a central printed circuit board (PCB) such as a motherboard, main board, system board, or logic board. The centralized circuit system 312 may also, or alternatively, include other printed circuit assemblies (PCAs) or communication channel media.

In an example embodiment, the processor 202 is configured to, with the content of the memory 204, and optionally with other components described herein, to cause the apparatus 200 to generate animated image associated with the multimedia content. In an embodiment, the multimedia content may be prerecorded and stored in the apparatus, for example the apparatus 200. In another embodiment, the multimedia content may be captured by utilizing the device, and stored in the memory of the device. In yet another embodiment, the device 100 may receive the multimedia content from internal memory such as hard drive, random access memory (RAM) of the apparatus 200, or from external storage medium such as DVD, Compact Disk (CD), flash drive, memory card, or from external storage locations through Internet, Bluetooth®, and the like. The apparatus 200 may also receive the multimedia content from the memory 204.

In an example embodiment, the processor 202 is configured to, with the content of the memory 204, and optionally with other components described herein, to cause the apparatus 200 to capture the multimedia content for generating an animated image from the multimedia content. In an embodiment, the multimedia content may be associated with a scene. In an embodiment, the multimedia content may be captured by displacing the apparatus 200 in at least one direction. For example, the apparatus 200 such as a camera may be moved around the scene either from left direction to right direction, or from right direction to left direction, or from top direction to a bottom direction, or from bottom direction to top direction, and so on. In some embodiments, the apparatus 200 may be configured to determine a direction of movement at least in parts and under some circumstances automatically, and provide guidance to a user to move the apparatus 200 in the determined direction. In an embodiment, the apparatus 200 may be an example of a media capturing device, for example, a camera. In some embodiments, the apparatus 200 may include a position sensor, for example the position sensor 210 for guiding movement of the apparatus 200 to determine direction of movement of the apparatus for capturing the multimedia content.

In an embodiment, the multimedia content may include a stationary portion and a mobile portion. The mobile portion of the multimedia content may include a plurality of objects. For example, the multimedia content may include a scene of an elephant wagging her tail and flapping her ears. In this scene, the stationary portion may include the body of the elephant except the tail and the ears, while the mobile portion in the captured scene may include the tail and the ears.

In an example embodiment, the processor 202 is configured to, with the content of the memory 204, and optionally with other components described herein, to cause the apparatus 200 to generate a depth map associated with the motion of the at least one object of the multimedia content. As used herein, the term ‘depth map’ may refer to an image comprising depth measurement of various objects in the scene. The depth measurement may provide a three dimensional (3-D) information obtained from a two dimensional (2-D) image. In an alternative embodiment, the depth map may be generated based on the movement of the media capturing device or the apparatus 200. In some other embodiments, the depth map may be generated from alternative technologies, for example, 3D cameras, optical and depth sensors, and the like. In an example embodiment, a processing means may be configured to generate the depth map of the multimedia content. An example of the processing means may include the processor 202, which may be an example of the controller 108.

The depth map may facilitate in segmenting the multimedia content into a foreground portion and a background portion. In an embodiment, segmenting may refer to a process of partitioning a multimedia content, such as an image into multiple segments. In an embodiment, the segmentation may be utilized for detecting boundaries or contours and/or between various objects in the multimedia content, thereby facilitating in detection of a plurality of distinct objects in the multimedia content. A continuation of depth in the multimedia content forms an object, while a discontinuity is utilized for segmenting the objects. In an embodiment, the multimedia content is segmented into the background portion and the foreground portion based on the depth map. In an embodiment, the captured multimedia content may include a stationary background portion and a mobile foreground portion. In another embodiment, the captured multimedia content may include a mobile background portion and a stationary foreground portion. In some other embodiments, the captured multimedia content may include a mobile background portion and a mobile foreground portion. In an example embodiment, a processing means may be configured to perform the segmentation of the plurality of objects based on the depth map for determining the motion of the plurality of objects. An example of the processing means may include the processor 202, which may be an example of the controller 108. In alternate embodiments, segmenting may be done by methods other than based on ‘depth map’ determination. For example, a user may chose a face portion as an object, and may segment the object. In an embodiment, the segmenting may be performed in a manner similar to two dimensional segmenting methods.

In an embodiment, the processor 202 is configured to, with the content of the memory 204, and optionally with other components described herein, to cause the apparatus 200 to generate an object mobility content indicative of motion of the plurality of objects in the multimedia content. In an embodiment, the object mobility content includes a first image associated with the stationary portion of the multimedia content, a plurality of second images associated with the mobile portion of the objects of the multimedia content, images of the at least one object, and a location information associated with the location of at least one object in the multimedia content. In some embodiments, the plurality of second images comprises a distinct second image corresponding to one or more respective objects of the plurality of objects of the multimedia content. In various other embodiments, the plurality of second images comprises a distinct image for a respective sequence of images associated with the motion of each objects of the plurality of objects. In an embodiment, the first image and the second image are generated based on the depth map. For example, frames of the multimedia content may be divided into the background portion and the foreground portion based on the depth information derived from the depth map, thereby categorizing the multimedia content into the foreground portion and the background portion.

In an embodiment, one of the background portion and the foreground portion may be associated with the stationary portion of the multimedia content, and the other is associated with the mobile portion of the multimedia content. For example, in a scene having a person standing in front of a moving train, the background portion (for example, the train) is mobile while the foreground (for example, the person) is stationary. In another example of scene having a person standing in front of door and waving his hand, the background portion (for example, the door) is stationary while the foreground (for example, the person's hand) is mobile.

In an embodiment, wherein the background portion is still and the foreground portion is in motion, the first image may include an image associated with the background portion, while the plurality of second images may include a sequence of images associated with a motion of the mobile objects in the foreground portion. In the present embodiment, the first image may be generated by extracting at least a portion of the background portion from the sequence of images associate with a motion of the at least one object in the multimedia content. The at least the portions of the background portions extracted from the sequence of images may be blended together to generate the background portion. In an embodiment, blending the background portions is performed in order to account for lighting variations that may be caused during the capturing of the multimedia content. In the present embodiment, the plurality of second images may be generated by recording the sequence of images associated with the motion of the at least one object in the foreground portion of the multimedia content.

In another embodiment, wherein the background portion is in motion and the foreground portion is still, the first image may include a sequence of images associated with the motion of the background portion, while the second image may include still image associated with the foreground portion. In the present embodiment, the first image for example the background image (in motion) is generated by recording a sequence of images associated with the motion of the at least one object in the background portion. The second image may be generated by capturing the image of the still foreground portion.

In yet another embodiment, the background portion of the multimedia content may be in motion while the foreground portion may be still. For example, in case of a pedestrian walking on a busy road, the pedestrian may be a mobile object, while traffic on the busy road in the background portion of the pedestrian is also in motion. In the present embodiment, for generating the animated image, since the background portion as well as the foreground portion are in motion, the background portion or the first image may be rejected and may be replaced with a still image. The still image may be captured in a camera mode of the media capturing device. Alternatively, the still image may be a stored image, such as an image stored in a computation device, or an image downloaded from internet, or an image generated by scanning another image. The still image may also be retrieved from any source apart from those mentioned herein without departing from the scope of the technology. In the present embodiment, the plurality of second images may be generated as the sequence of images associated with the motion of the at least one object in the foreground portion of the multimedia content. In an embodiment, the sequence of images may be stored in a memory, for example, the memory 204 of the apparatus 200. In some example embodiments, the sequence of images may be stored in the memory in any of the formats including, but not limited to, a Graphics interchange Format (Gif) format, a PNG format, a video format and the like.

In an embodiment, the object mobility content includes location map information. In an embodiment, the processor 202 is configured to, with the content of the memory 204, and optionally with other components described herein, to cause the apparatus 200 to generate the location map information associated with a location of the at least one object in the multimedia content. For example, for the multimedia content having a plurality of trees spaced apart from each other, the location map information may include information regarding the location of each of the plurality of trees. In an alternative embodiment, the object map information may include a relative distance between the plurality of trees. In some embodiments, the location map information may include a difference of distances of the plurality of objects from a reference location or reference point.

In an embodiment, the processor 202 is configured to, with the content of the memory 204, and optionally with other components described herein, to cause the apparatus 200 to store the object mobility content. In an embodiment, the object mobility content may be stored in a memory, for example, the memory 204.

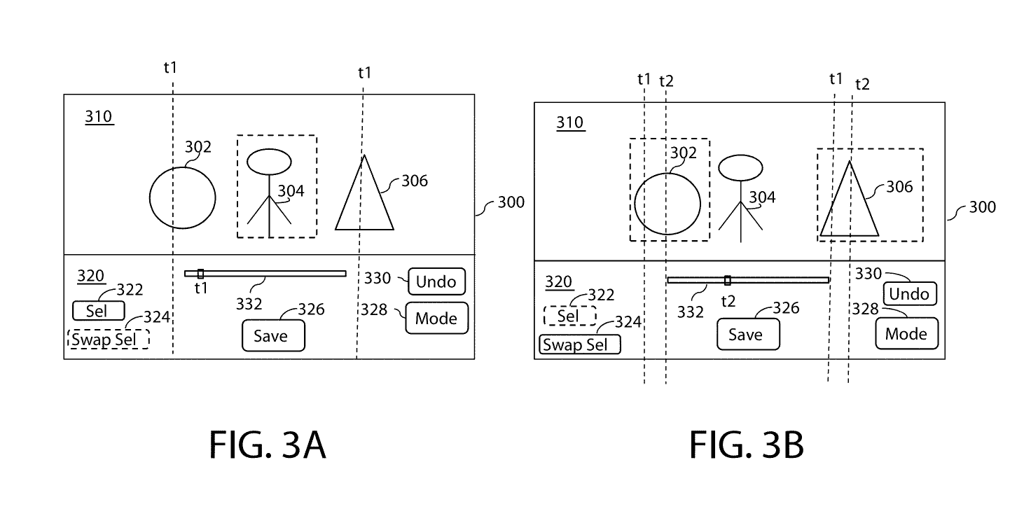

In an embodiment, the processor 202 is configured to, with the content of the memory 204, and optionally with other components described herein, to cause the apparatus 200 to receive a request for generating an animated image from the multimedia content. In an example embodiment, a processing means may be configured to receive the request for generating the animated image. An example of the processing means may include the processor 202, which may be an example of the controller 108. In an embodiment, the request is received from a user. In an embodiment, the request may be received on a user interface, for example the user interface 206. An example representation of a user interface for receiving the request for generating the animated image is explained in conjunction with FIG. 3.

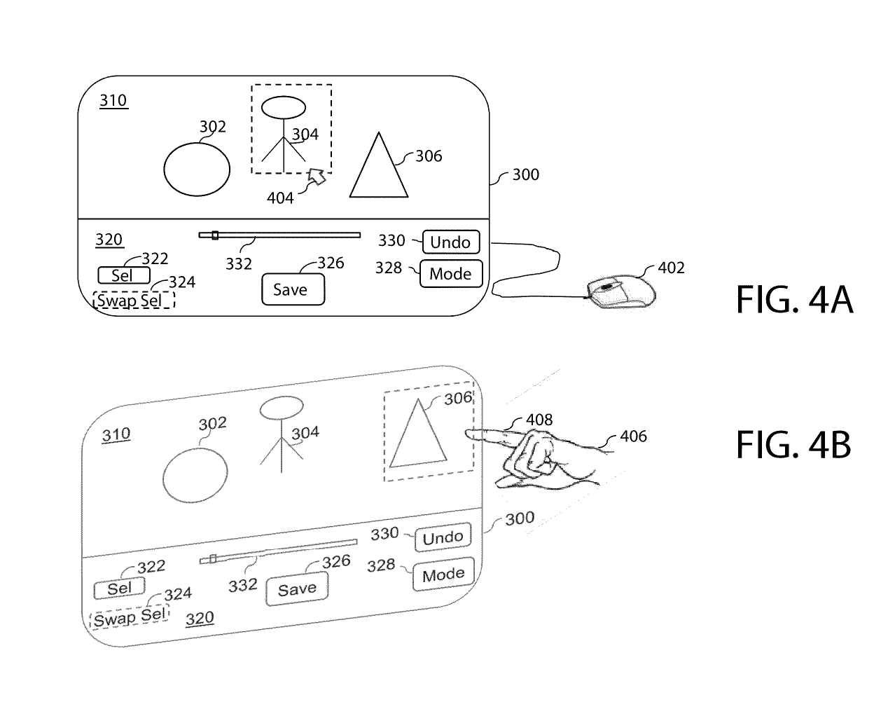

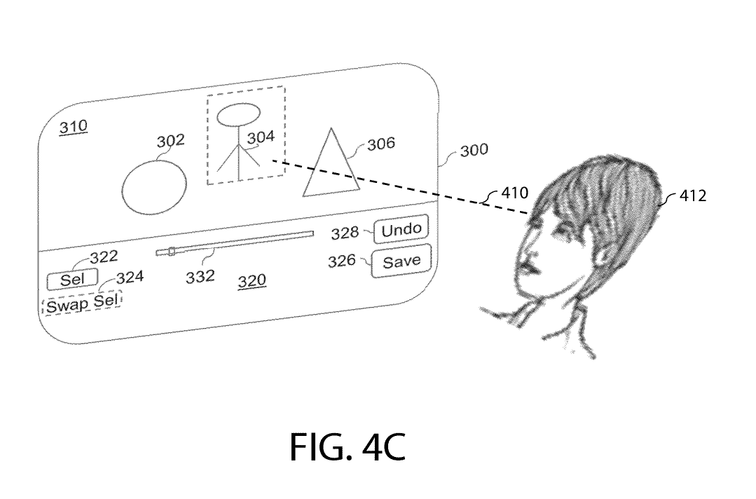

In an embodiment, the processor 202 is configured to, with the content of the memory 204, and optionally with other components described herein, to cause the apparatus 200 to facilitate a selection of at least one object from the plurality of objects for generating the animated image. In an embodiment, the selected at least one objects may be mobile objects in the animated image while the unselected objects may be stationary. The selection of the objects may be swapped in various alternative embodiments. For example, in some alternative embodiments, the selected objects may be stationary while the unselected objects may be mobile in the animated image. The selection of mobile and stationary objects is discussed in more detail in conjunction with FIGS. 3A and 3B. In an embodiment, the selection of the at least one object is performed by a user action. In an embodiment, the user action may include a mouse click, a touch on a display of the user interface, a gaze of the user, and the like. In an embodiment, the selected at least one object may appear highlighted on the user interface. The user interface for displaying the plurality of objects, the selected and deselected objects on a user interface, and various options for facilitating the selection of objects and/or options are described in detail in conjunction with FIGS. 4A, 4B and 4C.

In an embodiment, the processor 202 is configured to, with the content of the memory 204, and optionally with other components described herein, to cause the apparatus 200 to select a stationary (or constant) portion in the multimedia content based on the selection of the at least one object. The stationary portion is indicative of the first image. In an embodiment, the stationary portion may form the background portion of the animated image. In an embodiment, the stationary portion may be masked in all the images associated with the sequence of images based on the mobility of the at least one object.

In an embodiment, the processor 202 is configured to, with the content of the memory 204, and optionally with other components described herein, to cause the apparatus 200 to access the object mobility content associated with the selected at least one object. In an embodiment, a processing means may be configured to access the object mobility content associated with the selected at least one object. An example of the processing means may include the processor 202, which may be an example of the controller 108.

In an embodiment, the processor 202 is configured to, with the content of the memory 204, and optionally with other components described herein, to cause the apparatus 200 to generate an animated image associated with the multimedia content based on the selection of the at least one object and the object mobility content associated with the at least one object. For example, in a multimedia content having two objects in the foreground portion, the user may select only one object to be in motion in the animated image. In that case, the object mobility information associated with the selected object may be accessed for facilitating the selected object to be in motion in the animated image while the other object may be kept still. Also, the first image associated with the background portion of the animated image may be accessed, and the animated image may be generated.

In an embodiment, the processor 202 is configured to, with the content of the memory 204, and optionally with other components described herein, to cause the apparatus 200 to facilitate selection of a mode associated with the at least one object. In an embodiment, the mode is indicative of a level of speed of motion of the at least one object in the animated image associated with the multimedia content. In an embodiment, the mode may include an information on the mode of movement of the objects as being still or in motion in the animated image. In another embodiment, the mode may include the information of speed of the moving objects in the animated image. For example, in the multimedia content having two objects in the foreground portion, when one object is selected to be in motion and the other object is selected to be still, then the mode may be accessed for determining the speed of the motion of the selected object. In an embodiment, the level of speed of the motion of the selected object may vary from very high, a high speed, a medium speed, a low speed, a very low speed, a nil speed and the like. The speed of the motion may be adjusted based on the mode.

In some embodiments, the mode may include a direction of motion of the object in the multimedia content. In some other embodiments, the mode may be indicative of a repetitive or non-repetitive motion of the objects. For example, an animated image of a person may include a scene of a person walking on a street. Herein, the animated image may show the feet of the person going in a forward direction, and thereafter returning backwards in the opposite direction. As an exemplary scenario, the motion of the feet in the forward direction may be captured in, for example, frames 1 till frame 10. Then, the whole sequence of the forward motion and the backward motion may be reconstructed in the animate image by selecting a forward-backward mode, wherein initially the frames 1 to 10 may be played, and thereafter, the frames 10 to 1 may be played. In this way, a repetition of the frames (or the sequence of images) being played in the forward sequence and thereafter in the reverse sequence may give an illusion of a walking person. In an embodiment, the mode may also facilitate the selection of the repetitive motion and/or a non-repetitive motion of the object. The animated images comprising the motion of the object in more than one direction may enhance the user experience while accessing the animated image. In an embodiment, a processing means may be configured to facilitate inclusion of motion of the at least one object in more than one direction in the animated image. An example of the processing means may include the processor 202, which may be an example of the controller 108.

In an embodiment, the mode may be provided by a user input. In an embodiment, the user input may be provided by utilizing a user interface, for example the user interface 206. In an embodiment, the user input for the mode may be facilitated by one of a mouse click, a touch screen and a user gaze. For example, when a user may gaze an object in the animated image, the object may at least in parts and under some circumstances automatically starts moving, or vice versa. An example representation of various ways of facilitating the user input through the user interface for selection of mode are explained in conjunction with FIGS. 4A, 4B and 4C.

In an embodiment, the processor 202 is configured to, with the content of the memory 204, and optionally with other components described herein, to cause the apparatus 200 to display the animated multimedia content. In an embodiment, the animated multimedia content may be displayed on a user interface. In an embodiment, the animated image may be stored in a memory, for example, the memory 204. In an embodiment, animated image may be displayed by displaying the first image, and rendering a first plurality of pixels associated with the second images in a region where the at least one object is absent as transparent. Also, a second plurality of pixels associated with the at least one object are rendered as translucent, thereby displaying the animated image.

In an embodiment, the processor 202 is configured to, with the content of the memory 204, and optionally with other components described herein, to cause the apparatus 200 to generate the animated image at least in parts and under some circumstances automatically. In some example embodiments, the animated image may be generated based on object detection. For example, when a face portion is detected in a multimedia content, the face portion may be at least in parts and under some circumstances automatically selected as stationary or mobile portion in the animated image. In another example, the objects in the front may be selected as stationary and rest of the objects may be selected as mobile, or vice-versa. It will be understood various embodiments for the automatic generation of the animated images are possible without departing from the spirit and scope of the technology. Various embodiments of generating animated image from a multimedia content are further described in FIGS. 3A to 6B.

FIGS. 3A and 3B illustrate a user interface (UI) 300 for generating animated image from a multimedia content in an apparatus, for example the apparatus 200, in accordance with an example embodiment. In an embodiment, the UI 300 may include a viewfinder mode for illustrating multimedia content and facilitating generation of animated images therefrom. In another embodiment, the UI may include a camera mode for illustrating multimedia content and facilitating generation of animated images therefrom.

In an embodiment, the animated image may include a plurality of objects, of which at least one object may be mobile object and at least one object may be stationary. For example, as illustrated in FIG. 3A, an object 302 may be in motion, while objects 304 and 306 may be stationary. Various examples of the plurality of objects may include a vehicle, a road, a pedestrian, a building, a lamppost, and the like. In another example, the plurality of objects may include various portion of a creature, for example an elephant, of which few of the body portions may be mobile while rest of the body portions may be stationary. For example, a tail, a trunk and ears of the elephant may be mobile while rest of the body parts such as legs, head, eyes may be stationary. Without limiting the scope of present technology, examples of the plurality of objects may include any article, item, artifact, and the like that may be captured by an image capturing device.

In FIG. 3A, the UI 300 is shown that may be an example of a user interface 206 of the apparatus 200. In the example embodiment as shown in FIG. 3A, the user interface 300 is caused to display a scene area 310 and an option display area 320. In an example embodiment, the scene area 310 displays a viewfinder of the image capturing and animated image generation application of the apparatus 200. For instance, as the apparatus 200 moves in a direction, the preview of a current scene focused by the camera of the apparatus 200 also changes and is simultaneously displayed in the screen area 310, and the preview displayed on the screen area 310 can be instantaneously captured by the apparatus 200. In another embodiment, the screen area 310 may display a pre-recorded multimedia content of the apparatus 200.

In an example embodiment, the option display area 320 facilitates provisioning of various options for selection of the at least one object in order to generate an animated image. In the option display area 320, a plurality of options may be displayed. In an embodiment, the plurality of options may be displayed by means of various options tabs such as a selection tab (shown as ‘Sel’) 322, a swap selection tab (shown as ‘Swap sel’) 324, a save tab (shown as ‘Save’) 326, a mode selection tab (shown as ‘Mode’) 328, and a selection undo tab (shown as ‘undo’) 330. In some embodiments, the selection tab 322 may facilitate in selection of at least one object from the plurality of objects on the UI 300 for generating the animated image. In an embodiment, the selection tab 322 may facilitate selection of multiple objects that may be shown in motion in the animated images.

In an embodiment, upon operating the selection tab 322 in the option display area 320, various objects that may be desired to be in motion may be selected. For example, upon operating the selection tab 322, the at least one object, for example, the object 302 is selected based on the user input, in the screen area 310. In an embodiment, the at least one object that may be required to be stationary in animated image may be selected.

In an embodiment, operating the swap selection tab 324 facilitates in swapping the selection and/or motion of the objects (refer to FIG. 3B) being selected by operating the selection tab 322. For example, if upon operating selection tab 322, the object 304 is selected to be in motion while the object 302 is stationary, then, upon selection of the swap selection tab 324, the selected object 304 becomes stationary while the object 302 becomes mobile in the animated image. In an embodiment, the at least one object may be selected by pointing a pointing device, such as a mouse at the at least one object on the UI 300, without even operating the selection tab 322. In various other embodiments, the selection may be performed by utilizing a touch screen user interface, a user gaze selection and the like.

In an embodiment, the selection of one or more options, such as operation of selection tab 322, and swap selection tab 324 may be saved to generate an animated image based on the selection. In an embodiment, the selection may be saved by operating the ‘Save’ tab 326 in the options display area 320. In an embodiment, the mode selection tab 328 facilitates in selection of the mode of motion of the at least one object in the multimedia content. The mode is indicative of a speed of motion of the at least one object in the animated image associated with the multimedia content. In an embodiment, the mode may include an information on the mode of movement of the objects as being still or in motion in the animated image. In another embodiment, the mode may include the information of speed of the moving objects in the animated image. In an embodiment, the UI 300 may include a slide bar, for example, slide bar 332 for playing the animated image based on the modes selected for the at least one object.

In various embodiments, the selection of the ‘undo’ tab 330 facilitates in reversing the last selected and/or saved options. For example, upon selecting an object such as the object 302, the user may decide to deselect the object 302, and instead select the object 304. In an embodiment, the undo tab 328 may be operated for reversing the selection of the object 302, and thereafter the object 304 may be selected by operating the selection tab 322 in the option display screen 320.

In an embodiment, selection of various tabs, for example, the selection tab 322, the swap selection tab 324, the save tab 326, the mode selection tab 328 and the selection undo tab 330, may be facilitated by a user action. Also, as disclosed herein in various embodiments, various options being displayed in the options display area are represented by tabs. It will however be understood that these options may be displayed or represented in various devices by various other means, such as push buttons, and user selectable arrangements. In an embodiment, selection of the at least one object and various other option in the UI for example the UI 300 may be performed by, for example, a mouse-click, a touch screen user interface, detection of a gaze of a user and the like. Various embodiments describing the selection of the objects and/or options in the UI are described in conjunction with FIGS. 4A, 4B and 4C.

FIGS. 4A, 4B and 4C illustrate various embodiments for performing selection for generating animated images in accordance with various example embodiments. For example, FIG. 4A illustrates selection of at least one object and/or options by means of a mouse. As illustrated in FIG. 4A, an object, for example the object 304 is selected by a click of a, for example, a mouse 402. In alternative embodiments, the mouse may be replaced by any other pointing device as well, for example, a joystick, and other similar devices. As illustrated the selection of the object by the mouse may be presented to the user by means of a pointer for example an arrow pointer 404 on the user interface 300. In some embodiments, the mouse may be configured to select options and/or multiple objects as well on the user interface 300.

In another example embodiment, FIG. 4B illustrates selection of the at least one object and/or options by means of a touch screen interface associated with the UI 300. As illustrated in an example representation in FIG. 4B, at least one object for example, the object 306 may be selected by touching the at least object with a finger-tip (for example, a finger-tip 406) of a hand (for example, a hand 408) of a user displayed on a display screen of the UI 300.

In yet another embodiment, FIG. 4C illustrates selection of the at least one object and/or options by means of a gaze (represented as 410) of a user 412. For example, as illustrated in FIG. 4C, a user may gaze at least one object displayed on a display screen of a user interface for example, the UI 300. In an embodiment, based on the gaze 410 of the user 412, the at least one object may be selected for being in motion in the animated image. In alternative embodiments, various other objects and/or options may be selected based on the gaze 410 of the user 412. In an embodiment, the apparatus, for example, the apparatus 200 may include sensors and other gaze detecting means for detecting the gaze or retina of the user for performing gaze based selection.

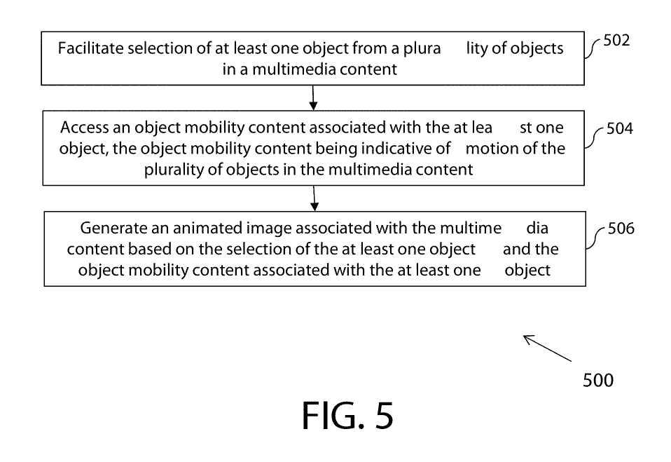

FIG. 5 is a flowchart depicting an example method for generation of animated image in multimedia content, in accordance with an example embodiment. The method depicted in flow chart may be executed by, for example, the apparatus 200 of FIG. 2. In an embodiment, the multimedia content includes a video recording or a video shot in a burst mode, for example, for about 3-4 seconds. In an embodiment, the multimedia content may include a stationary portion and a mobile portion. The mobile portion of the multimedia content may include plurality of objects of which at least one object is in motion.

At block 502, a selection of at least one object from a plurality of objects in a multimedia content is facilitated. In an embodiment, the multimedia content may be captured prior to selection of the at least one object. In an embodiment, the multimedia content may be captured by a multimedia capturing device, such as, the device 100. Examples of the multimedia capturing device may include, but are not limited to, a camera, a mobile phone having multimedia capturing functionalities, and the like. In an embodiment, the multimedia content may be captured by using 3-D cameras, 2-D cameras, and the like.

At block 504, an object mobility content associated with the at least one object is accessed. In an embodiment, the object mobility content is indicative of motion of the plurality of objects in the multimedia content. In an embodiment, the object mobility content includes a first image, a plurality of second images, and a location map information associated with the multimedia content. In an embodiment, the first image is associated with the stationary portion while the plurality of second images may include the mobile portion of the multimedia content. In an embodiment, the captured multimedia content may include a stationary background portion and a mobile foreground portion. In another embodiment, the captured multimedia content may include a mobile background portion and a stationary foreground portion. In yet another embodiment, the captured multimedia content may include a mobile background portion and a mobile foreground portion.

In an embodiment, a selection of a mode of at least one object is facilitated. In an embodiment, the mode is indicative of a speed of motion of the at least one object in the animated image associated with the multimedia content. In an embodiment, the mode may include an information whether the at least one object should be still or in motion. In another embodiment, the mode may include the information of speed of the moving objects in the animated image. For example, in the multimedia content having two objects in the foreground portion, when one object is selected to be in motion and the other object is selected to be still, then the notion information may be accessed for determining the speed of the motion of the selected object. In an embodiment, the speed of the motion of the selected object may vary from high to medium to a low speed. In an embodiment, the speed of the motion of the objects may be adjusted in the animated image based on the mode.

At block 506, an animated image associated with the multimedia content is generated based on the selection of the at least one object and the object mobility content associated with the at least one object. For example, in a multimedia content having two objects in the foreground portion, the user may select only one object to be in motion in the animated image. In that case, the object mobility information associated with the selected object may be accessed, and the other object may be kept still. Also, the first image associated with the background portion of the animated image may be accessed, and the animated image may be generated.

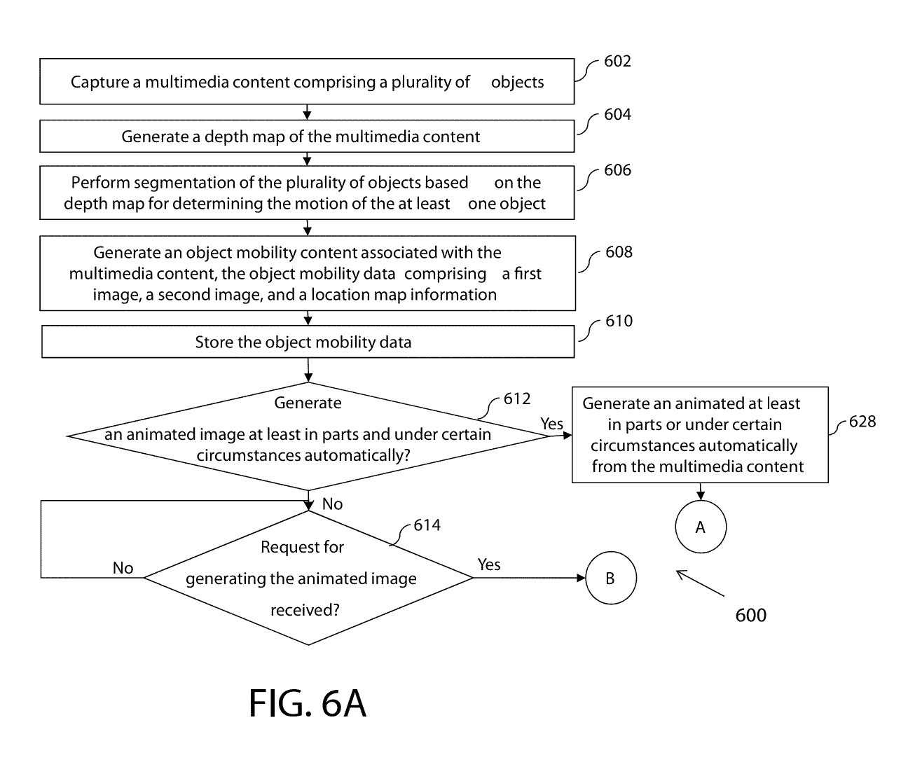

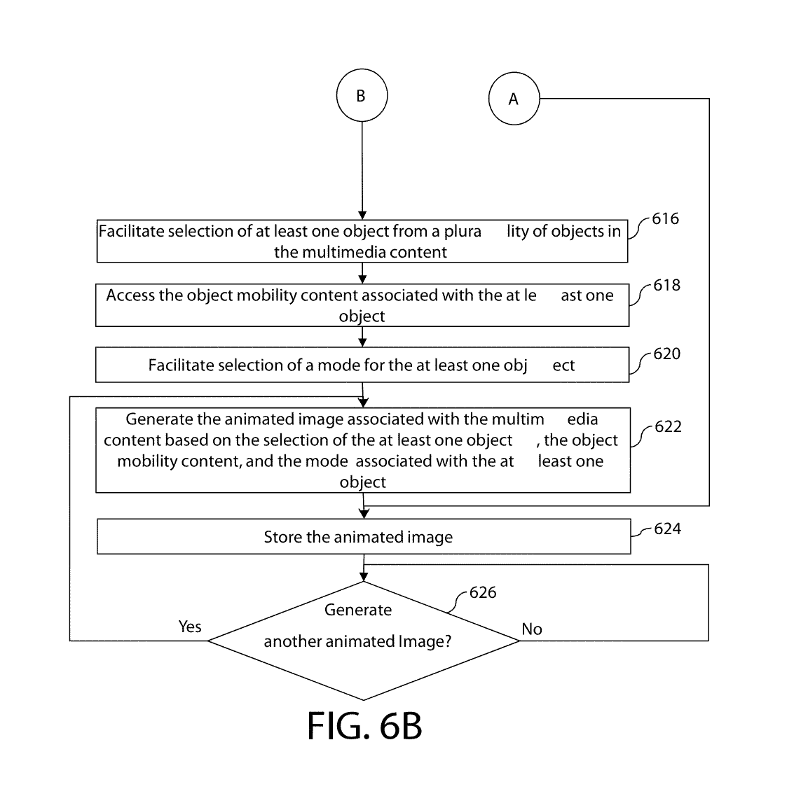

FIGS. 6A-6B is a flowchart depicting an example method 600 for generation of animated image associated with a multimedia content, in accordance with another example embodiment. The method 800 depicted in flow chart may be executed by, for example, the apparatus 200 of FIG. 2. Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 600 are described with help of apparatus 200. However, the operations of the method can be described and/or practiced by using any other apparatus.

At block 602, a multimedia content may be captured. In an embodiment, the multimedia content is a video recording or a video shot in a burst mode, for example, for about 3-4 seconds. Examples of the multimedia content may include a video presentation of a television program or a video shot, a short movie shot by a multimedia capturing device, and the like. In an embodiment, the multimedia content may be captured by a multimedia capturing device, such as, the device 100. Examples of the multimedia capturing device may include, but are not limited to, a camera, a mobile phone having multimedia capturing functionalities, and the like. In an embodiment, the multimedia content may be captured by using 3-D cameras, 2-D cameras, and the like.

In an embodiment, the multimedia content may include a stationary portion and a mobile portion. The mobile portion of the multimedia content may include a plurality of objects of which at least one object is in motion. For example, a video recording may include a tree in front of a (stationary or still) wall such that multiple leaves of the tree are in motion because of breeze. In an embodiment, the multimedia content may be captured by moving the media capturing device in at least one direction. For example, the media capturing device such as a camera may be moved around a scene either from left direction to right direction, or from right direction to left direction, or from top direction to a bottom direction, or from bottom direction to top direction, and so on. In an embodiment, the media capturing device may be configured to determine a direction of movement at least in parts and under some circumstances automatically, and provide a guidance to a user to move the media capturing device in the determined direction.

At block 604, a depth map of the multimedia content is generated. The ‘depth map’ may provide a depth measurement, for example, 3-D information associated with the multimedia content. In an embodiment, the depth map may be generated based on the movement of the media capturing device. In another embodiment, the depth map may be generated from alternative technologies, for example, 3D cameras, optical and depth sensors, and the like.

At block 606, a segmentation of the plurality of objects is performed based on the depth map for determining the motion of the at least one object. The depth map may facilitate in segmenting the multimedia content into the foreground portion and the background portion. In an embodiment, segmentation may refer to a process of partitioning a multimedia content, such as an image into multiple segments for locating distinct objects in the multimedia content, thereby simplifying the representation of the objects in the animated image. In an embodiment, the segmentation may be utilized for detecting boundaries or contours and/or between various objects in the multimedia content, thereby facilitating in detection of distinct objects in the multimedia content. In an embodiment, the depth map may facilitate in segmenting the multimedia content into a background portion and at least a foreground portion. In alternate embodiments, segmenting may be done by methods other than based on ‘depth map’ determination. For example, a user may chose a face portion as an object, and may segment the object. In an embodiment, the segmenting may be performed in a manner similar to two dimensional segmenting methods.

At block 608, an object mobility content associated with the multimedia content is generated. In an embodiment, the object mobility content is indicative of motion of the plurality of objects in the multimedia content. In an embodiment, the object mobility content includes a first image, a plurality of second images, and a location map information. In an embodiment, the first image is associated with the stationary portion while the plurality of second images comprises the mobile portion of objects of the multimedia content. In an embodiment, the mobile portion of the multimedia content may include a respective sequence of images associated with the mobility of the objects. In an embodiment, the multimedia content may include a stationary background portion and a mobile foreground portion. In another embodiment, the multimedia content may include a mobile background portion and a stationary foreground portion. In yet another embodiment, the multimedia content may include a mobile background portion and a mobile foreground portion.

In an embodiment, the location map information is associated with the location of at least one object in the multimedia content. In an embodiment, the first image and the second images are generated based on the depth map. For example, frames of the multimedia content may be divided into the background portion and the foreground portion based on the depth information derived from the depth map, thereby categorizing the multimedia content into the foreground portion and the background portion. Considering an exemplary illustration, for the multimedia content associated with a scene having a plurality of trees spaced apart from each other, the location map information may include information regarding the location of each of the plurality of trees. In another example, the location map information may include a relative distance between the plurality of trees.

In an embodiment, one of the background portion and the foreground portion may be associated with the stationary portion of the multimedia content, and the other is associated with the mobile portion of the multimedia content. In an embodiment, wherein the background portion is still and the foreground portion is in motion, the first image may include a sequence of images associated with a motion of the background. In the present embodiment, the first image is generated by extracting at least the portion of the background portion from the sequence of images associate with a motion of the at least one object in the multimedia content. The portions of the background portion extracted from the sequence of images may be blended together to generate the background portion of the at least one object. In an embodiment, the portions of the background portion may be blending in order to account for lighting variations that may be caused during the capturing of the multimedia content.

In an embodiment, the second images include the sequence of images associated with the motion of the respective objects. The sequence of images may be recorded and stored in a memory, for example, the memory 204 of the apparatus 200. In some example embodiments, the sequence of images may be stored in the memory in any of the formats including, but not limited to, a Gif format, a PNG format, a video format and the like. In an embodiment, the depth map may be analyzed and a continuity of the depth map from one frame of the multimedia content to another frame may be utilized for determining the motion of the objects.

In another embodiment, the background portion of the multimedia content may be in motion while the foreground portion may be still. For example, in case of a pedestrian walking on a busy road, the pedestrian may be an object, while traffic on the busy road in the background of the pedestrian is also in motion. In the present embodiment, for generating the animated image, the background portion or the first image may be rejected and may be replaced with a still image. The still image may be captured in a camera mode of the media capturing device. Alternatively, the still image may be a stored images, such as an image stored in a computation device, or an image downloaded from internet, or an image generated by scanning another image. The still image may also be obtained from any source apart from those mentioned herein without departing from the scope of the technology. In the present embodiment, the second images may be generated as the sequence of images associated with the motion of the objects in the foreground portion of the multimedia content.

At block 610, the object mobility content associated with the plurality of the objects is stored. In an embodiment, the object mobility content is stored in a memory, for example the memory 204. At block 612, it may be determined whether an animated image associated with the multimedia is to be generated at least in parts or under certain circumstances automatically. If it is determined at block 612 that the animated image is not to be generated automatically, then at block 614, it is determined whether a request is received for generating the animated until the request for generating the animated image is received at block 614.

In an embodiment, it may be determined at block 614 that the request for generating the animated image from the multimedia content is received. In an embodiment, the request may be received by utilizing a user interface, for example the UI 206. An exemplary UI for receiving the request is explained in conjunction with FIGS. 3A and 3B. In an embodiment, if it is determined at block 614 that the request for generating the animated image is received, then a selection of at least one object from the plurality of objects is facilitated at block 616. In an embodiment, the selected at least one object may be made mobile while the unselected objects may be made stationary in the animated image. The selection of the at least one object may be swapped in alternative embodiments. For example, in alternative embodiments, the selected objects may be made stationary while the unselected objects may be made to assume mobile configurations in the animated image. In an embodiment, the selection of the at least one object is performed by a user action. In an embodiment, the user action may include a mouse click, a touch on a display of the user interface, a gaze of the user, and the like. In an embodiment, the selected at least one object may appear highlighted on the UI 300. An exemplary UI for facilitating selection of the at least one object is explained in conjunction with FIGS. 4A, 4B and 4C.

In an embodiment, the stationary portion of the multimedia content is indicative of the first image. In an embodiment, the stationary portion may form the background portion of the animated image. In an embodiment, the stationary portion may be masked in all the images associated with the sequence of images in the animated image. At block 618, the object mobility content associated with the selected at least one object is accessed. In an embodiment, the object mobility content may include the first image comprising the background portion, the second images comprising the sequence of images and the location information associated with the selected at least one object in the multimedia content.

At block 620, selection of a mode associated with the at least one object may be facilitated. In an embodiment, the mode is indicative of a speed of motion of the at least one object in the animated image associated with the multimedia content. In an embodiment, the mode may include an information whether the at least one object should be still or in motion in the animated image. In another embodiment, the mode may include the information of speed of the moving objects in the animated image. For example, in the multimedia content having two objects in the foreground portion, when one object is selected to be in motion and the other object is selected to be still, then the motion information may be accessed for determining the speed of the motion of the selected object. In an embodiment, the speed of the motion of the selected object may vary from a high speed to a medium speed to a low speed. The speed of the motion may be adjusted based on the mode. In some embodiments, the mode may be indicative of a repetitive and/or non-repetitive motion of the objects. In this embodiment, the sequence of images may include movement of the at least one object in one direction, and the movement of the object in the other direction may be recreated by playing the sequence of images in the reverse direction. For example, an animated image of a person may include a scene of a person walking on a street. Herein, the motion of the feet in the forward direction may be captured in a sequence of images, say in frames 1 to 10, and the backward motion of the feet may be reconstructed by playing the sequence of images in the reverse direction.

In various embodiments, the mode may be provided by means of a user input. In an embodiment, the user input may be provided by utilizing a user interface. In an embodiment, the user input for the adjusting/inputting the mode may be facilitated by one of a mouse click, a touch screen and a user gaze. An example representation of various ways of facilitating the user input through the user interface for selection of mode is explained in conjunction with FIGS. 4A, 4B and 4C.

At block 622, an animated image associated with the multimedia content is generated based on the selection of the at least one object, the object mobility content and the mode associated with the at least one object. For example, in a multimedia content having two objects in the foreground portion, the user may select only one object to be in motion in the animated image. In that case, the object mobility information associated with the selected object may be accessed, and the other object may be kept still. Also, the first image associated with the background portion of the animated image may be accessed, and the animated image may be generated.

In an embodiment, the animated image generated at block 622 may be stored at block 624. In an embodiment, the animated image may be stored in a memory, for example, the memory 204. After storing the animated image, it is determined at block 626 whether another animated image is to be generated until it is determined that another animated image is to be generated. If at block 626, it is determined that another animated image is to be generated, then a selection of another at least one object of the plurality of objects may be performed at block 616, and another animated image may be generated by following block 616 to block 626.

If however at block 612, it is determined the generation of the animated image is to be performed at least in parts and under certain circumstances automatically, then the animated images is generated at least in parts or under certain circumstances automatically at block 628. In certain embodiments, the generation of the animated image at least in parts and under certain circumstances automatically may be performed based on previous settings of a device 100 and/or the apparatus 200. In various other embodiments, the previous settings may be adjusted based on a user input. In some example embodiments, the animated image may be generated based on detection of the at least one object. For example, based on previous setting of the apparatus, whenever moving hands or moving arms are detected in a multimedia content, the moving hands/arms may be at least in parts and under some circumstances automatically selected as one of stationary or mobile portions in the animated image. In another example, the objects in the front may be selected as stationary while rest of the objects (for example, those in the background portion) in the multimedia content may be selected as mobile, or vice-versa. It will be understood that numerous other examples and embodiments for the automatic generation of the animated images are possible without departing from the spirit and scope of the technology.

At block 624, the generated animated image is stored. In an embodiment, the generated animated image may be stored in a memory, for example, the memory 204. In an embodiment, upon the animated image is generated, it may be determined whether another animated image is to be generated at block 626. If at the block 626, it is determined that another animated image is to be generated, then a selection of another at least one object of the plurality of objects may be performed at block 616, and another animated image may be generated by following block 616 to block 622.

In an embodiment, the animated image generated at block 622 may be displayed. In an embodiment, the animated image may be displayed by utilizing a user interface, for example, the UI 206. In an embodiment, displaying the animated image may include displaying the first image, and rendering a first plurality of pixels associated with the second image in a region where the at least one object is absent as transparent. Also, a second plurality of pixels associated with the at least one object are rendered as translucent.

In an example embodiment, a processing means may be configured to perform some or all of: facilitating selection of at least one object from a plurality of objects in a multimedia content; accessing an object mobility content associated with the at least one object, the object mobility content being indicative of motion of the plurality of objects in the multimedia content; and generating an animated image associated with the multimedia content based on the selection of the at least one object and the object mobility content associated with the at least one object. An example of the processing means may include the processor 202, which may be an example of the controller 108.

To facilitate discussion of the method 600 of FIGS. 6A-6B, certain operations are described herein as constituting distinct steps performed in a certain order. Such implementations are exemplary and non-limiting. Certain operation may be grouped together and performed in a single operation, and certain operations can be performed in an order that differs from the order employed in the examples set forth herein.

Moreover, certain operations of the method 600 are performed in an automated fashion. These operations involve substantially no interaction with the user. Other operations of the method 600 may be performed by in a manual fashion or semi-automatic fashion. These operations involve interaction with the user via one or more user interface presentations (as described in FIGS. 3A, 3B, 4A, 4B, and 4C).

Without in any way limiting the scope, interpretation, or application of the claims appearing below, a technical effect of one or more of the example embodiments disclosed herein is to facilitate generation of animated image from the multimedia content. The animated image is generated by segmenting the multimedia content to determine a plurality of stationary and mobile portions in the multimedia content. In an embodiment, various mobile objects in the multimedia content may be determined, and frames associated with motion of the mobile objects may be stored as a sequence of images. Also, the stationary objects may be stored, for example to be utilized as stationary background portion in the animated image. In an embodiment, whenever an animated image is to be generated, the stored sequence of images for the object desired to be in motion and the stationary background portion are retrieved, and the animated is generated therefrom. In another embodiment, the motion of the objects in the animated image may be generated by adjusting a mode of the respective objects. In an embodiment, the mode is indicative of speed of the respective objects, that may vary from zero (nil speed) to a maximum possible speed. Since, the method facilitates selection of the objects that may be stationary and/or the objects that may be mobile in the animated image, the method provides a flexibility in generation of the animated image, thereby enhancing a user experience. In another embodiment, the animated images may be generated at least in parts or under certain circumstances automatically. The method may find application in generating animated panorama images.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

We claim:

1. A method comprising:
facilitating selection of at least one object from a plurality of objects in a multimedia content;
accessing an object mobility content associated with the at least one object, the object mobility content being indicative of motion of the plurality of objects in the multimedia content; and
generating an animated image associated with the multimedia content based on the selection of the at least one object and the object mobility content associated with the at least one object.

2. The method of claim 1 further comprising displaying selected at least one object in motion, and unselected objects of the plurality of objects as stationary.

3. The method of claim 1 further comprising displaying selected at least one object as stationary, and unselected objects of the plurality objects in motion.

4. The method as claimed in claim 1 further comprising:
generating a depth map of the multimedia content;
segmenting of the plurality of objects based on the depth map for determining the motion of the plurality of objects.

5. The method as claimed in claim 1 further comprising generating the object mobility content, the object mobility content comprising:
a first image associated with a background portion of the multimedia content, and
a plurality of second images associated with objects of the plurality of objects, the plurality of second images comprising a respective sequence of images associated with the motion of the objects of the plurality of objects.

6. The method as claimed in claim 5, wherein generating the first image comprises:
extracting at least a portion of the background portion from the sequence of images; and
blending at least the portion of the background portion extracted from the sequence of images to generate the first image.

7. The method as claimed in claim 1, wherein the object mobility content further comprises a location map information associated with a location of the at least one object in the multimedia content.

8. The method as claimed in claim 1, further comprising facilitating selection of a mode associated with the at least one object, the mode being indicative of at least one of a level of speed and a direction of motion of the at least one object in the animated image associated with the multimedia content.

9. The method as claimed in claim 5 further comprising:
displaying the first image;
rendering a first plurality of pixels associated with the second image in a region where the at least one object is absent as transparent; and
rendering a second plurality of pixels associated with the at least one object as translucent.

10. An apparatus comprising:
at least one processor; and
at least one memory comprising computer program code, the at least one memory and the computer program code configured to, with the at least one processor, cause the apparatus to at least perform:
facilitate selection of at least one object from a plurality of objects in a multimedia content;
access an object mobility content associated with the at least one object, the object mobility content being indicative of motion of the plurality of objects in the multimedia content; and
generate an animated image associated with the multimedia content based on the selection of the at least one object and the object mobility content associated with the at least one object.

11. The apparatus as claimed in claim 10, wherein the apparatus is further caused, at least in part, to: display the selected at least one object in motion, and unselected objects of the plurality of objects as stationary.

12. The apparatus as claimed in claim 10, wherein the apparatus is further caused, at least in part, to: display the selected at least one object as stationary, and unselected objects of the plurality objects in motion.

13. The apparatus as claimed in claim 10, wherein the apparatus is further caused, at least in part, to:
generate a depth map of the multimedia content;
segment the plurality of objects based on the depth map for determining the motion of the plurality of objects.

14. The apparatus as claimed in claim 10, wherein the apparatus is further caused, at least in part, to generate the object mobility content, the object mobility content comprising:
a first image associated with a background portion of the multimedia content, and
a plurality of second images associated with objects of the plurality of objects, the plurality of second images comprising a respective sequence of images associated with the motion of the objects of the plurality of objects.

15. The apparatus as claimed in claim 10, wherein, to generate the first image, the apparatus is further caused, at least in part, to perform:
extract at least a portion of the background portion from the sequence of images; and
blend at least the portion of the background portion extracted from the sequence of images to generate the first image.

16. The apparatus as claimed in claim 14, wherein the object mobility content further comprises a location map information associated with a location of the at least one object in the multimedia content.

17. The apparatus as claimed in claim 14, wherein the apparatus is further caused, at least in part, to facilitate selection of a mode associated with the at least one object, the mode being indicative of at least one of a level of speed and a direction of motion of the at least one object in the animated image associated with the multimedia content.

18. The apparatus as claimed in claim 10, wherein the apparatus is further caused, at least in part, to perform:
display the first image;
render a first plurality of pixels associated with the second image in a region where the at least one object is absent as transparent; and
render a second plurality of pixels associated with the at least one object as translucent.

19. A computer program product comprising at least one computer-readable storage medium, the computer-readable storage medium comprising a set of instructions, which, when executed by one or more processors, cause an apparatus at least to perform:
facilitating selection of at least one object from a plurality of objects in a multimedia content;
accessing an object mobility content associated with the at least one object, the object mobility content being indicative of motion of the plurality of objects in the multimedia content; and
generating an animated image associated with the multimedia content based on the selection of the at least one object and the object mobility content associated with the at least one object.

20. The computer program product as claimed in claim 19, wherein the apparatus is further caused, at least in part, to perform:
generating a depth map of the multimedia content;
segmenting of the plurality of objects based on the depth map for determining the motion of the plurality of objects.

21. The computer program product as claimed in claim 19, wherein the apparatus is further caused, at least in part, to perform: generating the object mobility content, the object mobility content comprising:
a first image associated with a background portion of the multimedia content, and
a plurality of second images associated with objects of the plurality of objects, the plurality of second images comprising a respective sequence of images associated with the motion of the objects of the plurality of objects.

22. The computer program product as claimed in claim 21, wherein the apparatus is further caused, at least in part, to perform generating the first image by:
extracting at least a portion of the background portion from the sequence of images; and
blending at least the portion of the background portion extracted from the sequence of images to generate the first image.
